(19) United States
(12) Patent Application Publication
(10) Pub. No.: US 2021/0384530 A1
(43) Pub. Date: Dec. 9, 2021

(54) METHOD FOR SEALING A FUEL CELL

(71) Applicant: Robert Bosch GmbH, Stuttgart (DE)

(72) Inventor: Felix Wald, Stuttgart (DE)

(21) Appl. No.: 17/284,530

(22) PCT Filed: Aug. 22, 2019
(86) PCT No.: PCT/EP2019/072506

§ 371 Date: Apr. 12, 2021

(30) Foreign Application Priority Data
Oct. 10, 2018 (DE) 10 2018 217 290.0

(51) Int. Cl. H01M 8/0286; H01M 8/0284

(52) U.S. Cl. CPC H01M 8/0286; H01M 2250/20; H01M 8/0284

(57) ABSTRACT

The invention relates to a method for sealing a fuel cell (5) and to a fuel cell (5) which is produced using such a method. The fuel cell (5) has at least one membrane-electrode unit (42) and bipolar plates (18, 22). The method has the steps of attaching a seal material (54) to at least one side of the membrane-electrode unit (42) in a bonded manner, attaching a precursor (62) to seal points (58) of the at least one bipolar plate (18, 22), placing the at least one bipolar plate (18, 22) on the membrane-electrode unit (42) such that the seal points (58) together with the precursor (62) come into contact with the seal material (54), and pressing the at least one bipolar plate (18, 22) and the membrane-electrode unit (42) together under the effect of pressure and/or temperature such that the seal material (54) forms a bonded connection to the at least one bipolar plate (18, 22) and to the membrane electrode unit (42).

### BACKGROUND OF THE INVENTION

The present invention relates to a method for sealing a fuel cell, and a fuel cell which is sealed by means of such a method.

In fuel cell systems, the oxidizing agent—oxygen from the ambient air—is generally used to react with hydrogen in the fuel cell to produce water and therefore to provide electrical power through electrochemical conversion. Seals are arranged in the fuel cell to isolate an inner part of the fuel cell from the environment.

A method for sealing a coolant chamber of a bipolar plate of a fuel cell is known from DE 10 2012 221 730 A1. In this method, a seal for sealing the gas chamber is positioned such that both bipolar plate halves of the bipolar plate are contacted by the seal.

The background of the invention consists in that, in the case of a fuel cell stack, the greatest risk of a defect during the manufacture of the stack comes from the sealing points in the cell. The overall risk of defects with a total of several 1000 sealing points per stack increases considerably so that, after completion of the fuel cell stack, a relatively high reject rate of defective fuel cell stacks in the region of 10% arises. The high reject rate of defective fuel cell stacks therefore increases the price of the defect-free fuel cell stack. A lot of effort is therefore spent on ensuring the leak-tightness of the seals. This increases the price of the fuel cell stack considerably.

### SUMMARY OF THE INVENTION

The object of the present invention is therefore to specify a method for sealing a fuel cell, with which the sealing properties of the sealing points are improved and which enables simpler and therefore more economical production of the seals.

In this case, the inventive method for sealing a fuel cell comprises the steps of applying a sealing material to at least one side of the membrane-electrode unit in a bonded manner, applying a precursor to sealing points of the at least one bipolar plate, placing the at least one bipolar plate on the membrane-electrode unit so that the sealing points with the precursor come into contact with the sealing material, and pressing the at least one bipolar plate together with the membrane-electrode unit under pressure and/or under temperature so that the sealing material forms a bonded connection to the at least one bipolar plate and the membrane electrode unit.

A precursor in the sense of the invention is something which happens or exists before something else and has an influence thereon. In this case, the precursor essentially determines the future sealing properties of the sealing material.

The inventive method for sealing a fuel cell specifies a simple method with which the sealing material can be connected to the membrane-electrode unit and the bipolar plates in a bonded manner. Economical manufacture of such a seal is thus possible.

In addition, a seal produced in such a way is advantageous in that a high degree of leak-tightness is enabled. The reject rate of the fuel cells due to inadequate sealing can therefore be substantially reduced. In addition, the costs for producing such a fuel cell are therefore reduced.

In a preferred embodiment of the invention, a primer or a vulcanizing agent is used as the precursor. Primers are bonding agents with which the adhesive properties of surfaces are improved. The sealing properties of a sealing material can thus be improved.

A vulcanizing agent is an agent with which a chemical process for converting rubber or related polymers into more durable materials takes place, for example, via the addition of sulfur. These additions change the polymer through the formation of cross-linkages (bridges) between the individual polymer chains. A particularly durable connection to the bipolar plates is thus formed, whereby the sealing properties are substantially improved.

In a further preferred embodiment of the invention, FKM or EPDM is used as the sealing material. EPDM has a very good aging resistance. Moreover, EPDM is resistant to oxygen. FKM has a good heat resistance, a low gas permeability and an excellent aging resistance. A sealing material with excellent sealing properties can therefore be produced using FKM or EPDM.

In an advantageous configuration of the invention, a bead is formed on the bipolar plate before or after the application of the precursor. A bead in the sense of the invention is a manually or mechanically produced channel-like depression. This bead is advantageous in that the rigidity of the bipolar plate is increased so that a sufficiently high pressure force can be applied to the sealing material after the bracing of the bipolar plates.

Moreover, a cross-section of a region to be sealed is reduced so that the bead forms a metal barrier over a significant part of the sealing height. The gas diffusion through the sealing material is thus reduced. In addition, the bead has the same coefficient of thermal expansion as the base material of the bipolar plate. The thermal properties are thus improved so that thermal expansion of the bead results in an additional pressing-together at the sealing points and thereby increases the leak-tightness of the sealing points.

The sealing material is preferably applied by printing. The application of the sealing material by printing can be easily incorporated as part of an automated manufacturing process so that a sealing material applied in this way can be economically produced.

The sealing material is particularly preferably applied by means of a screen printing technique. A high-quality sealing material can be efficiently batch-produced using a screen printing technique. The sealing properties of a sealing material produced thereby are therefore improved. Moreover, with a high number of units, a sealing material produced in this way can be produced economically.

In an advantageous further development, the sealing material is applied by spraying. The proposed application of sealing material by spraying contributes significantly to the cost-effective manufacture.

The object of the invention is additionally achieved by a fuel cell, which is sealed according to the inventive method. In this case, the fuel cell comprises at least one membrane-electrode unit, to which a sealing material is applied in a bonded manner, and bipolar plates, which have sealing points which abut against the sealing material of the membrane-electrode unit and form a sealing connection, wherein a precursor is applied to the sealing points of at least one bipolar plate so that a bonded connection is formed between the sealing material and the at least one bipolar plate.

The advantages mentioned with respect to the method can be achieved by such a fuel cell, which is sealed according to the inventive method.

In a preferred exemplary embodiment, the precursor is a primer or a vulcanizing agent. In a further preferred exemplary embodiment, the sealing material is FKM or EPDM. The advantages already mentioned with respect to the method can therefore be achieved.

The bipolar plates preferably have a bead at the sealing points. In this case, the beads have the advantages already mentioned with respect to the method.

The object of the invention is moreover achieved by a fuel cell stack having at least one fuel cell, which is sealed according to the inventive method. The invention additionally specifies a motor vehicle having such a fuel cell stack. The above-mentioned advantages can be achieved with such a fuel cell stack or a motor vehicle which has such a fuel cell stack.

### BRIEF DESCRIPTION OF THE DRAWINGS

An exemplary embodiment of the invention is illustrated in the drawing and explained in more detail in the description below.

FIG. 1 shows a sectional view of an exemplary embodiment of a fuel cell which is sealed according to the inventive method.

### DETAILED DESCRIPTION

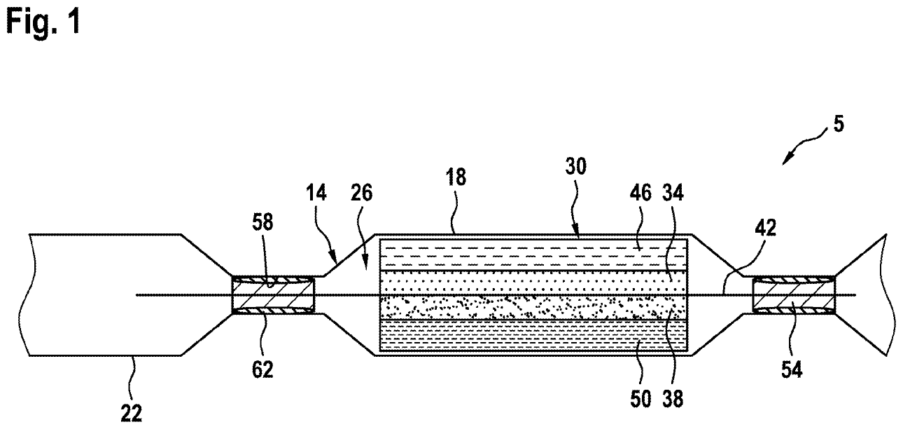

FIG. 1 shows a sectional view of an exemplary embodiment of a fuel cell 5 which is sealed according to the inventive method. This method is explained with reference to a detail of an individual cell of the fuel cell 5. The fuel cell 5 is formed from a cathode bipolar plate 18 having a bead 14. An anode bipolar plate 22 is arranged in a mirror-inverted manner with respect to the cathode bipolar plate 18 so that the beads 14 of both bipolar plates 18, 22 are opposite one another. Channels 26 are thus formed between the cathode bipolar plate 18 and the anode bipolar plate 22.

A layered structure 30 is arranged within the channels 26. This layered structure 30 is shown by way of example in a channel 26. In this case, the layered structure 30 is composed of a first and a second gas diffusion layer 34, 38, which are separated by a membrane-electrode unit 42. The oxygen 46 which is required for the oxidation flows between the first gas diffusion layer 34 and the cathode bipolar plate 18. The hydrogen 50 which is preferably used as fuel flows between the second gas diffusion layer 38 and the anode bipolar plate 22.

A sealing material 54 is applied to the membrane-electrode unit 42 in a bonded manner at the points at which the beads 14 of the cathode bipolar plate 18 and the anode bipolar plate 22 are opposite one another. Sealing points 58 are formed in regions of the beads 14 which come into contact with the sealing material 54. A precursor 62 has been applied to these sealing points 58 before the placement of the bipolar plates 18, 22.

As already described above, most defects arise at the sealing points 58. Leaks in such a fuel cell 5 occur at these sealing points 58 as a result of inadequate contact.

In a next step, the bipolar plates 18, 22 are pressed together under a high temperature and pressure, so that a bonded connection forms between the sealing material 54 and the respective bipolar plate 18, 22 at the sealing points 58 where the precursor 62 is applied.

1. A method for sealing a fuel cell (5), wherein the fuel cell (5) has a membrane-electrode unit (42) and a bipolar plate (18, 22), the method comprising the following steps:
applying a sealing material (54) to at least one side of the membrane-electrode unit (42) in a bonded manner,
applying a precursor (62) to sealing points (58) of the bipolar plate (18, 22),
placing the bipolar plate (18, 22) on the membrane-electrode unit (42) so that the sealing points (58) with the precursor (62) come into contact with the sealing material (54), and
pressing the bipolar plate (18, 22) together with the membrane-electrode unit (42) under pressure and/or under temperature so that the sealing material (54) forms a bonded connection to the bipolar plate (18, 22) and the membrane electrode unit (42).

2. The method for sealing a fuel cell (5) as claimed in claim 1, characterized in that a primer or a vulcanizing agent is used as the precursor (62).

3. The method for sealing a fuel cell (5) as claimed in claim 1, characterized in that FKM or EPDM is used as the sealing material (54).

4. The method for sealing a fuel cell (5) as claimed in claim 1, characterized in that a bead (14) is formed on the bipolar plate (18, 22) before or after the application of the precursor (62).

5. The method for sealing a fuel cell (5) as claimed in claim 1, characterized in that the sealing material (54) is applied by printing.

6. The method for sealing a fuel cell (5) as claimed in claim 5, characterized in that the sealing material (54) is applied by a screen printing technique.

7. The method for sealing a fuel cell (5) as claimed in claim 1, characterized in that the sealing material (54) is applied by spraying.

8. A fuel cell (5), which is sealed by means of a method for sealing as claimed in claim 1, wherein the fuel cell (5) comprises:
at least one membrane-electrode unit (42), to which a sealing material (54) is applied in a bonded manner, and
bipolar plates (18, 22), which have sealing points (58) which abut against the sealing material (54) of the membrane-electrode unit (42) and form a sealing connection, wherein a precursor (62) is applied to the sealing points (58) of at least one bipolar plate (18, 22) so that a bonded connection is formed between the sealing material (54) and the at least one bipolar plate (18, 22).

9. The fuel cell (5) as claimed in claim 8, characterized in that the precursor (62) is a primer or a vulcanizing agent.

10. The fuel cell (5) as claimed in claim 8, characterized in that the sealing material (54) is FKM or EPDM.

11. The fuel cell (5) as claimed in claim 8, characterized in that the bipolar plates (18, 22) have a bead (14) at the sealing points (58).

12. A fuel cell stack having at least one fuel cell (5) as claimed in claim 8.

13. A motor vehicle having a fuel cell stack as claimed in claim 12.

14. The method for sealing a fuel cell (5) as claimed in claim 2, characterized in that FKM or EPDM is used as the sealing material (54).

15. The method for sealing a fuel cell (5) as claimed in claim 14, characterized in that a bead (14) is formed on the bipolar plate (18, 22) before or after the application of the precursor (62).

16. The method for sealing a fuel cell (5) as claimed in claim 15, characterized in that the sealing material (54) is applied by printing.

17. The method for sealing a fuel cell (5) as claimed in claim 16, characterized in that the sealing material (54) is applied by a screen printing technique.

18. The method for sealing a fuel cell (5) as claimed in claim 17, characterized in that the sealing material (54) is applied by spraying.
